(19) United States
(12) Patent Application Publication
(10) Pub. No.: US 2019/0075740 A1
(43) Pub. Date: Mar. 14, 2019

(54) House plant watering device

(71) Applicant: Terry L. Cox, Warner Springs, CA (US)

(72) Inventor: Terry L. Cox, Warner Springs, CA (US)

(21) Appl. No.: 15/732,049

(22) Filed: Sep. 11, 2017

(51) Int. Cl. A01G 27/02; A01G 27/00

(52) U.S. Cl. CPC A01G 27/02; A01G 27/003; A01G 27/001

(57) ABSTRACT

This invention is directed toward an indoor flower growing device that automatically waters house plants and collects the drainage water. The device has a detachable bottom portion that contains a source of electrical power for the pumping of water to the plants while providing support for a decorative flower pot that contains a water reservoir and plant container and serves as a moisture barrier between the water reservoir and table top/floor. The unit provides water to the plant container and collects water that drains out of the plant containers for use in the next watering.

### CROSS REFERENCE TO RELATED APPLICATIONS

This application claims priority back to U.S. Provisional Patent Application No. 62/025,978, filed Jul. 17, 2015, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of in-house potted plants and watering devices, and more specifically toward a plant support device that automatically pumps water into a soil grown potted plant on a timed cycle, and then recovers the water that drains from the pot for use in subsequent waterings.

History of the invention's industry. While growing plants is optional and a hobby for most people, keeping plants alive and healthy can be a real challenge. Plants can grow in a variety of climates and environments, but with very few exceptions, plants need sunlight and water to grow. Placing a plant near a window or on a patio/deck will usually meet the sunlight requirement.

Water, on the other hand, is a different story. Too much or too little and you become the proud owner of a dead plant. It's been published and discussed in plant journals, that most house plants die from too much water (frequent over-watering) while in a close second place, plants die from lack of water (most likely the result of being neglected on a daily basis or forgotten during a trip). In our daily lives, maintaining a watering schedule for indoor plants can be very difficult to follow. A few days of neglect and your plants are dead. For this reason, the average indoor plant's life is measured in weeks, not years like outdoor plants.

The next consideration of indoor plant growing is the placement of the plant. Plants, like pets, can be messy. Besides dropping leaves, the pots can leak water, creating wet rings on tables and floors or even causing dry rot and structural failures. While plant stands may be the best solution for the placement of the potted plant, they most often do not address the plant's water needs.

There is currently no device that can allow indoor plants to thrive—much less live—and do so cleanly and with little effort on the part of the plant owner.

There exist on the market today plant stands the raise the plant above the floor, and drip basins that catch at least some of the overflow when a plant is overwatered. There are also a variety of timers that can be programmed to water a plant (or an area of plants) for a certain time period every day, or several days. However, none of these products do so cleanly: the timer that sends too much water into a pot will result in water overflowing the basin; a larger drip basin may catch more water but be less attractive: the pot stand may put the plant an attractive 3′ above the floor, but that only exacerbates the problem with water spilling out of the basin, as now the water doesn't just drip over the edge but rather falls 3′ before splattering all over the room.

Thus there has existed a long-felt need for a self-contained watering unit that can water plants on regular basis, not distract from the beauty of the potted plant and decorative flower pot, and prevent any excess water from spilling on the floor.

The current invention provides just such a solution by having a plant support system that not only waters the plant, but does so in a way that is inconspicuous to the casual observer and efficiently recovers and recycles excess water.

### OBJECTS OF THE INVENTION

It is therefore an object of the present invention to provide a means of keeping potted plants alive and healthy in an indoors environment.

Another object of the invention is to provide a means to keep a house clean when using houseplants for decoration and comfort.

Yet another object of the invention is to provide a means by which indoor plants can be watered precisely in both frequency and duration down to the seconds to match the plant's needs, with any overflow or excess water being collected such that it does not fall on the floor.

Another object of the invention is to allow for excess water to be captured in a manner that does not damage table tops or floors and rugs, and allows the excess water to be stored for subsequent waterings.

It is another object of the invention to extrapolate the same technologies used for the indoor potted plant version to commercial indoor open areas that can benefit from plants that cleanse and refresh the air.

Another object of the invention is the design of the system to be in modules that can be separated for both ease of maintenance, changing of plants, replacement of parts and cleaning of the water reservoir.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a cross-sectional line drawing of the invention showing basic layout and function of the invention.

FIG. 2 is an exploded two dimensional drawing of the invention of how the parts fit together.

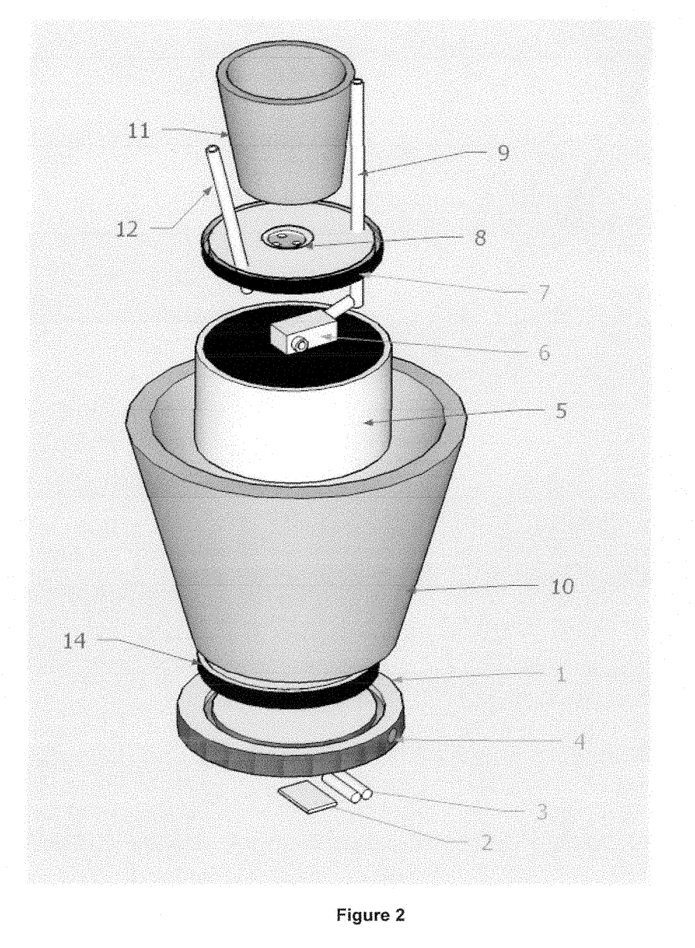

### REFERENCE NUMBERS USED

1. Base unit. Contains batteries and timer as well as an electrical connection to the pump and also serves as insulator and moisture barrier between reservoir and table top/floor.
2. Controller circuit board that can be precisely programmed in both frequency and duration down to seconds for the watering of the plants.
3. Rechargeable Batteries. Provides power for both controller and water pump.
4. Mini USB port for the recharging of the batteries that can be done with most cell phone chargers.
5. Water reservoir. Contains water supply as well as serving as the recovery basin for drainage from plants.
6. Submersible water Pump. Provides water pressure to water the plants.
7. Plant support platform and reservoir cover the plant container sits on that also includes a drain opening to receive the returning excess water from the plant watering.
8. A one way float valve that allows excess water to drain into the reservoir and prevents the refilling from the water input tube from leaving the reservoir.
9. Water supply line. Delivers water pumped from the reservoir to the plant container.
10. Exterior decorative flower pot. Conceals and contains the plant container with the potted plant and the reservoir with submersible water pump.
11. The Plant container that contains the soil and the potted plant and a drain hole at the bottom for the draining of the potted plant.
12. Water Input tube for adding water to reservoir.
13. Dip stick that access the water reservoir through the water input tube for the monitoring of the water level in the reservoir.
14. Bottom plate that is attached to decorative flower pot and is matched to seat flower pot securely on base unit as well as provide the electrical contact point between the power supply in the base and submersible water pump in water reservoir.

### DETAILED DESCRIPTION OF THE FIGURES

Many aspects of the invention can be better understood with references made to the drawings included with the submission. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

To summarize the invention, a submersible water pump in a reservoir of water pumps water to a potted plant contained in the plant container. The amount of water and time interval between waterings is controlled by a circuit board in the base unit that can be precisely programmed. A water supply line attached to the water pump, delivers water to the potted plant in the plant container that rest on the water reservoir cover. Any excess water drains out a drain hole in the plant container and is funneled back into the reservoir through the platform that covers the water reservoir where it can be used in subsequent waterings. This way, a homeowner can leave for extended periods of time and rely upon the invention to keep the plants watered, but not too wet.

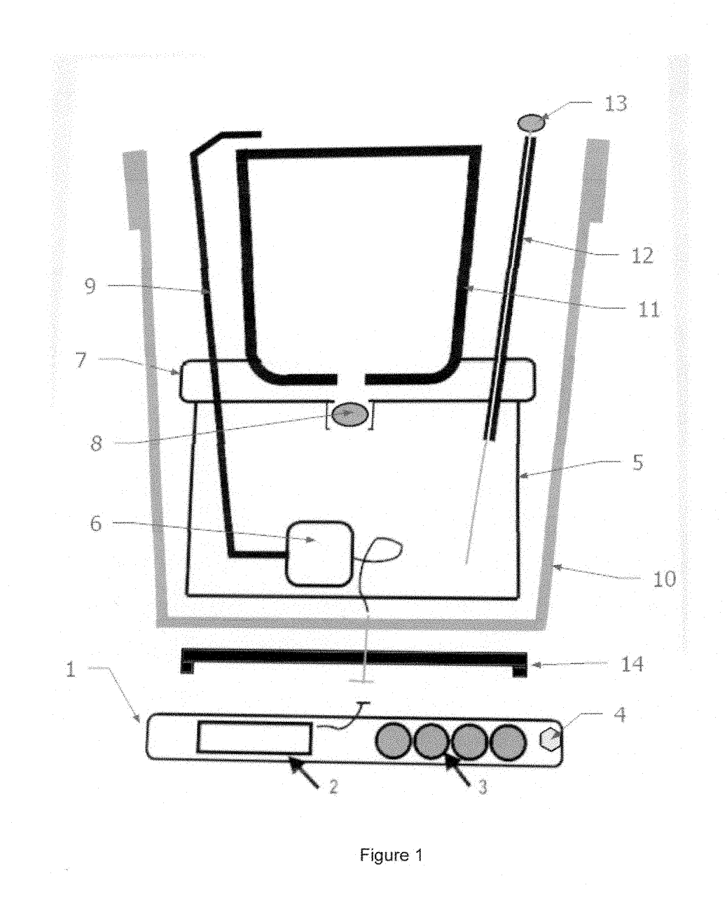

FIG. 1 is a cross-sectional line drawing of the invention according to a preferred form of the invention. The base unit, generally referenced as 1, provides not only a stable platform upon which the units rests, but houses the batteries and controller that sends electrical power to the pump. The base unit also serves has moisture barrier between the water reservoir and the surface the unit sits on and includes a mini USB port for the recharging of the batteries. The inside of the base contains a compartment for the battery pack 3 and controller 2. The top center raised area in the base unit contains the electrical contacts that connect to the bottom plate that is attached to the decorative flower pot that houses the water reservoir and potted plant.

The reservoir, generally referenced as 5, is a bowl from which water is pumped to water the plants, and into which excess water—runoff from the plants—is collected for subsequent waterings. The water reservoir is a container that may be round, square or any similar shape that would contain both water and the pump 6.

The pump 6 pumps water to the potted plant housed in the plant container. The pump 6 is regulated by a controller 2, with the time interval and the length of time the pump runs is set by the user. The pump is connected to the power supply in the base unit 1 with the batteries 3 and controller 2.

The lid 7 covers the water reservoir and serves as both a seat for the plant container and a cover to conceal the pump from view and prevent the growth of light requiring algae in the standing water.

The plant container 11 sits directly on the reservoir cover that also serves as the collector of the excess water draining from the plant container. The plant container is not attached to the reservoir cover and can be easily removed and the contained plant can be replaced with another plant without making any changes to the rest of the unit. The shape and size of the plant container will vary depending on the exterior decorator flower pot size and shape. There is also a drainage hole in the bottom of the plant container that lines up with the drain hole in the reservoir cover, through which excess water in the plant container can drain back into the reservoir 5.

The pump 6 takes water from the water reservoir 5 and pumps through the water supply tube 9 to the plant in the plant container. The water supply tube 9 is attached directly to the submersible water pump in the reservoir. After the water has been dispensed to the plant, the excess water drains back into the water reservoir 4 for the next watering.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device of claim 1, for ensuring the regular watering and proper drainage of potted plants comprising of:
a base unit, where the plurality of batteries provide electricity to a water pump,
a base unit that also serves as an insulator and moisture barrier between the unit and a table top or floor while serving as the platform for the user supplied decorative flower pot that conceals the entire watering apparatus.
a base unit with rechargeable batteries and a mini USB connector that works with common cell phone/tablets for the recharging of the batteries,
a base unit that is modular and can be easily separated from the upper unit that contains both the users decorative flower pot, the water supply and potted plant,
a controller that regulates a flow of water to the plant contained in the plant container,
an electrical connection that mates the base unit to the submersible water pump contained in the water reservoir,
a reservoir unit that contains water and a submersible pump and is concealed inside the users chosen decorative flower pot,
a water reservoir with a cover that supports the plant container and funnels the excess water dripping from the plant container that contains the potted plant back into the reservoir,
a submersible water pump that pumps a quantity of water from the reservoir through a water supply tube to the potted plant in the plant container that sits on the water reservoir cover,
a separate plant container that is easily removable and contains soil and a plant and includes an open top and a drainage hole in the bottom, such that a quantity of excess water from the watering cycle, can drain back to the reservoir.

2. The device of claim 2, where the plurality of batteries provide electricity to the pump and the base unit stabilizes and insolates the device from it's resting place, where a controller regulates the flow of water to the one or more plants contained in the plant container.

3. The device of claim 3, where the base unit additionally comprises of an electrical contact, and where the reservoir unit additionally comprises the electrical contact through the bottom plate on the decorator pot, where the base unit electrical contact can mate with the bottom plate contact to power to the pump.

4. The device of claim 4, where the water reservoir cover funnels quantity of drip water from the plant container back into the water reservoir.

5. The device of claim 5, where the base unit contains a Mini USB port for the recharging of the batteries, compatible with industry cell phone chargers,

6. The device of claim 6, additionally comprising the water input, where the water input comprises of a tube that passes through an opening in the reservoir cover, which provides the opening through which the quantity of water can be added to replenish the water level in the reservoir unit.

7. The device of claim 7, where the controller regulates the flow of water to plant container that houses the potted plant.

8. The device of claim 8, where the base unit additionally comprises of an electrical contact, and where the reservoir unit additionally comprises of the reservoir unit electrical contact, where the base unit electrical contact can mate with the reservoir unit electrical contact to supply power to the pump.

9. The device of claim 9, where, where the base unit is the cylindrical plate which has the height and the diameter, where the diameter is greater than the height, where the plurality of batteries provide electricity to the pump and where the base unit serves as a moisture barrier between the device and the table top or floor, where the controller regulates a flow of water to one or more plants contained in the plant container, and where the water reservoir collects the quantity of drip water from the plant container, and additionally comprising of the reservoir unit electrical contact in the bottom plate, where the base unit electrical contact can mate with the reservoir unit electrical contact to supply power to the pump.
